(19) United States
(12) Patent Application Publication
(10) Pub. No.: US 2005/0279537 A1
(43) Pub. Date: Dec. 22, 2005

(54) Motorized vehicle for maneuvering another wheeled apparatus

(76) Inventor: Ken Nguyen, Anaheim Hills, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/154,499

(22) Filed: Jun. 16, 2005

Related U.S. Application Data
(60) Provisional application No. 60/580,589, filed on Jun. 18, 2004.

(51) Int. Cl. B62D 1/00

(52) U.S. Cl. 180/11

(57) ABSTRACT

A motorized assisting vehicle (“MAV”) including a platform resting on at least one set of wheels, an extended arm, and a power supply coupled to a motor, the motor coupled to at least one wheel to maneuver the platform. The extended arm is adapted to couple to a first vehicle for propelling the first vehicle. The MAV may be releasably or non-releasably coupled to the first vehicle depending on the nature of the first vehicle for which the MAV propels. The platform of the MAV may be foldable so that the MAV may be conveniently transported. The MAV may be controlled by a wire or wireless control which communicates with the motor. An LCD display may also be provided to show the time, temperature, the battery charge and the like.

1. RELATED APPLICATION

This application claims priority to a provisional application having a Ser. No. 60/580,589, entitled MOTORIZED ASSISTING VEHICLE FOR MANEUVERING A WHEELED APPARATUS, filed Jun. 16, 2004, which is incorporated by reference.

### BACKGROUND OF THE INVENTION

1. Field of Invention

This invention relates to a motorized vehicle capable of coupling to a first vehicle for the maneuvering the first vehicle.

2. Background of Invention

Many people now shop at “super-warehouses,” such as Cost Co. or Sam's Club, to realize the cost-savings some of these stores offer. Many of the people that do shop at such stores are mothers and/or the elderly may find that shopping at such large stores to be overwhelming due to the physical size of the stores. For instance, even for well conditioned shoppers, pushing a shopping cart around the store with many of the bulk food items may prove to be challenging. This can present significant problems for shoppers, in particular, female and elderly shoppers.

Besides shoppers, visitors of theme parks may also find that walking around a large them park to be physically challenging. This may be especially true for parents who have to carry their children around the theme park. Accordingly, there is a need for a device that can assist people get around a large area.

### SUMMARY OF THE INVENTION

This invention is generally directed to a motorized assisting vehicle (“MAV”) that is capable of coupling to a first vehicle, such as a shopping cart, baby stroller or the like to propel that first vehicle. This is accomplished by providing a platform that is able to rest upon one or more wheels, a motor, and an extended arm for attaching to the first vehicle. Such a design allows for the MAV to releasably couple to the first vehicle so that the MAV may be detached from the first vehicle. Once the MAV is detached from the first vehicle, the MAV can be transported more easily.

The platform may be formed from light-weight material capable of supporting the weight of a full-grown adult. In addition, a joint may be provided proximate to the middle portion of the platform such that the platform may fold onto itself about the joint. Folding the platform may allow a user to transport the MAV more readily.

The invention may also provide a MAV that permanently attaches to a first vehicle, such as a baby stroller or the like, to mobilize the first vehicle. The platform may slide underneath the first vehicle such that the MAV and the first vehicle may conveniently be transported

Another feature of the invention is to provide a MAV with an LCD display to show the weather, the time, directional information and the like. This has the advantage of giving the user useful information for time management purposes.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a side view of the motorized assisting vehicle (“MAV”).

FIG. 2 is a top view of the MAV.

FIG. 3 is a side view a first alternative embodiment of the MAV attached to a stroller.

FIG. 4 is a top view of a first alternative embodiment of the MAV attached to a stroller.

FIG. 5 is a side view of a second alternative embodiment of the MAV attached to a stroller.

### DETAILED DESCRIPTION OF PREFERRED EMBODIMENTS OF THE INVENTION

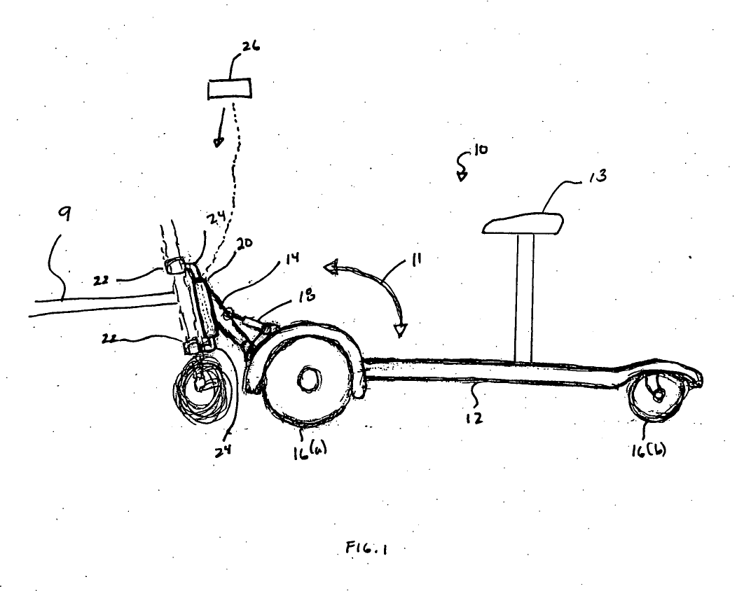

FIG. 1 illustrates generally a side view of a motorized assisting vehicle 10 (“MAV”) of the present invention. The MAV 10 is comprised of a platform 12 that is pivotally coupled to an extended arm 14. The platform 12 may rest upon two sets of wheels 16. Additionally, the platform 12 may be composed of Teflon® or another light-weight, sturdy material. The extended arm 14 may be configured in a prong shape with the ends shaped like claws 24 such that the claws 24 may grip the legs of a first vehicle 9. The first vehicle 9 may be a variety of vehicles, such as a shopping cart or baby stroller. Velcro® on the claw 24 secures the claw to the leg of the first vehicle 9, respectively. A first piston 20 may be disposed between the two claws 24. Additionally, a second piston 18 may couple to the extended arm 14 to the platform 12 so that the platform 12 may be folded when not in use. As shown by the directional arrows 11, the extended arm 14 may be folded toward the platform 12. When the platform 12 is in use, the pistons 18 and 20 may operate to absorb shock from the wheels 16(a) and 16(b). The MAV 10 may include a control 26 communicatively coupled to a motor 30 to maneuver the first vehicle and MAV in the back, forward, left and right directions. The control 26 may be communicatively coupled to the motor via a wire or wirelessly. A battery 28 (not shown in this figure) may be provided to provide power to the motor 30 (not shown in this figure). The platform 12 may also be releasably coupled to a seat 13 to allow a user to sit on the seat 13.

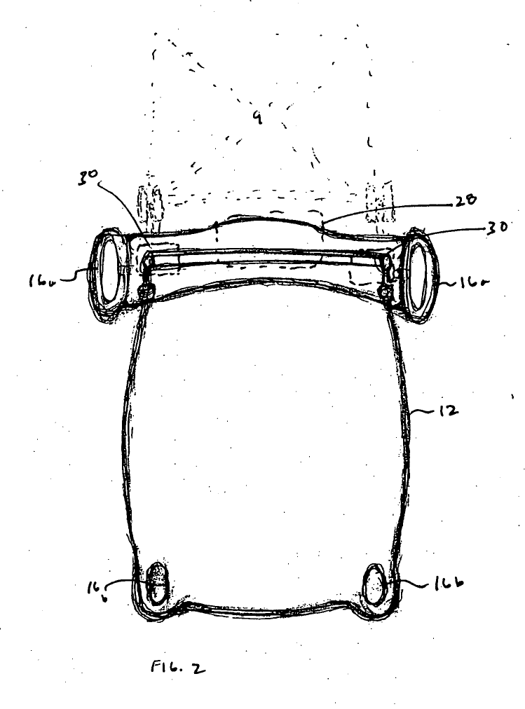

FIG. 2 illustrates a top view of the MAV 10. The platform 12 may provide a wide surface area for a user to stand or sit upon while operating the MAV 10 by the wire or wireless control 26. As shown in FIG. 2, the MAV 10 also includes a first set of wheels 16(a) that are near to the front end of the platform 12. The MAV 10 also includes a second set of wheels 16(b) that are near the back end of the platform 12. The second set of wheels 16(b) may be smaller than the first set of wheels 16(a). The battery 28 (shown in hashed marks) may be positioned proximate to the motor 30 and located toward the front of the MAV 10 to supply power to the motor 30.

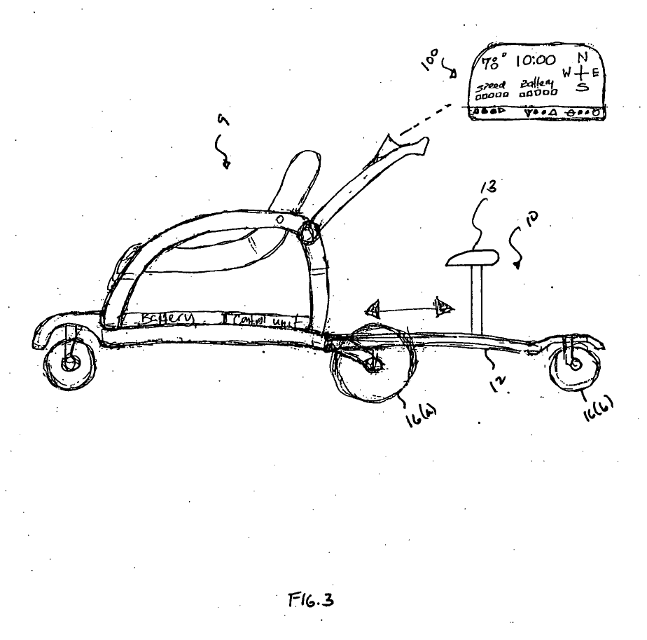

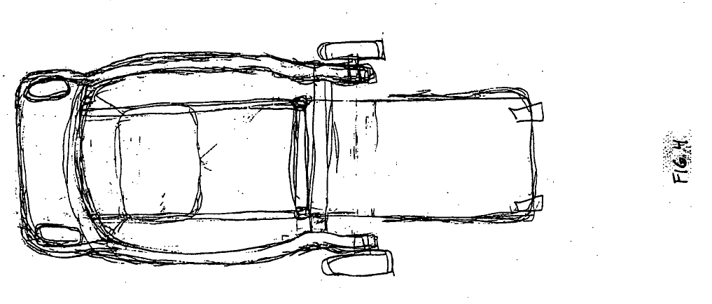

Referring now to FIG. 3, a side view of the MAV 10 is coupled to a first vehicle 9. The MAV 10 may be configured to slide underneath the first vehicle 9. The first vehicle 9 may be, for example, a baby stroller or the like. The sliding mechanism allows the MAV 10 to be transported with the first vehicle 9 as one unit. FIG. 3 also illustrates a wire or wireless LCD display 100 connected to the MAV 10. The LCD display 100 may give useful information such as the temperature, time, direction, speed and battery strength of the MAV 10 to the user. This feature may also aid the user in being aware of his/her surroundings. FIG. 4 shows a top view of the first alternative embodiment of the MAV 10 connected to the first vehicle 9.

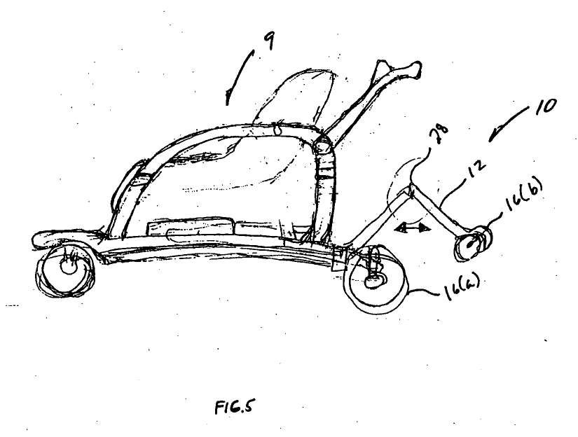

FIG. 5 illustrates that the platform 12 may be collapsible along a joint 28. When the user is finished using the MAV 10, he/she may conveniently collapse or fold the platform 12 by pushing the second set of wheels 16(b) toward the first set of wheels 16(a). In this embodiment, the first vehicle 9 such as a stroller, may be provided with the MAV 10 that is permanently attached to the first vehicle 9. With the collapsible joint 28, the MAV 10 may remain attached to the first vehicle 9, yet fold along the joint 28 for convenient storage. Alternatively, the MAV 10 may be detached from the first vehicle 9 if the first vehicle belongs to another, such as grocery store shopping cart.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thererof.

1. A motor assisting vehicle capable of coupling to a first vehicle and propelling the first vehicle, the motor assisting vehicle comprising:
a platform resting on at least two sets of wheels;
an extended arm attached to the platform adapted to couple to the first vehicle;
a motor connected to a power supply, the motor coupled to at least one set of wheels to drive the at least one set of wheels; and
a control device capable of communicating with the motor for operating the motor.

2. The motor assisting vehicle according to claim 1, where the extended arm is adapted to couple to back end of the first vehicle.

3. The motor assisting vehicle according to claim 1, where the platform a pivot point between the two sets of wheels and the platform is adapted to fold along the pivot point.

4. The motor assisting vehicle according to claim 1, where the platform has a seat.

5. The motor assisting vehicle according to claim 1, where the control device is a LCD display.
